(19) United States
(12) Patent Application Publication
(10) Pub. No.: US 2003/0126290 A1
(43) Pub. Date: Jul. 3, 2003

(54) Context filter in a mobile node

(76) Inventors: Ram Gopal Lakshmi Narayanan, Woburn, MA (US); Man Li, Bedford, MA (US)

Correspondence Address: Robert Rolnik, 6000 Connection Dr. , 1-4-755, Irving, TX, 75039, US

(21) Appl. No.: 10/309,365

(22) Filed: Dec. 2, 2002

Related U.S. Application Data
(60) Provisional application No. 60/339,208, filed on Dec. 3, 2001.

(51) Int. Cl. G06F 15/173

(52) U.S. Cl. 709/242

(57) ABSTRACT

In mobile IP networks, when a mobile node (MN) moves from one cell to another, handover occurs. The result of the handover is that the MN connects to the network through a new access router (AR). The handover may occur between access routers of the same or different administrative domains. In all cases, the information related to the mobile node has to be transferred from the old AR to the new AR in order to minimize the effect of the change of access routers. This is the so-called context transfer.

The present invention claims priority of provisional patent application No. 60/339,208, filed Dec. 03, 2001, the contents of which are incorporated herein.

### BACKGROUND

In mobile IP networks, when a mobile node (MN) moves from one cell to another, handover occurs. The result of the handover is that the MN connects to the network through a new access router (AR). The handover may occur between access routers of the same or different administrative domains. In all cases, the information related to the mobile node has to be transferred from the old AR to the new AR in order to minimize the effect of the change of access routers. This is the so-called context transfer.

During inter handovers, context related to MN are moved from old access router (say AR1) to new access router (say AR2). It may happen that the new access router AR2 or the new communication path established cannot meet the needs of existing active sessions or possible future sessions. For example, it may be that the available bandwidth along the new path is less than that of the previous one. Hence QoS may degrade. It may also be that AR2 does not support an encryption algorithm the MN may request for its future communication sessions. In all these cases, if the MN is not informed about the changes, the services to existing sessions may be degraded or compromised. In addition, the MN may send messages to initiate new sessions and those messages may be rejected by AR2 because AR2 cannot support the required services. This results in a waste of wireless bandwidth.

In wireless networks, bandwidth is a precious resource. Every effort should be make to efficiently utilize this resource. The above-mentioned references are exemplary only and are not meant to be limiting in respect to the resources and/or technologies available to those skilled in the art.

### SUMMARY

The proposals in this invention comprise two aspects. First, we propose a mechanism where after a handover the MN is informed of the capability changes in AR and the new communication path. Second we propose a filter mechanism inside the MN to filter out messages that will be rejected by the new AR due to changes resulted from a handover.

### BRIEF DESCRIPTION OF THE DRAWINGS

The disclosed inventions will be described with reference to the accompanying drawings, which show important sample embodiments of the invention, wherein:

FIG. 1 is a reference system for transferring context of a mobile node between autonomous systems; and

FIG. 2 shows how and when these filters are applied and used for normal operation.

### DETAILED DESCRIPTION

An embodiment may inform the Mobile Node (MN) about the changes of Access Router (AR) capabilities or the communication path. The MN will perform context filters for both incoming and outgoing packets accordingly. The advantages this embodiment may provide are:

1. Efficient utilization of wireless spectrum, by making decisions on the MN for out going packets;

2. For incoming packets received from the new access routers, the “context filter” rules are applied and, in case the packets get rejected, then these packets may be generated by hacker who is interested in attacking the MN;

3. If the service is degraded, and if there is an application level signaling, this is communicated to the application and the service levels may be renegotiated;

4. Reduces number of filtering rules in the Access routers and improves the performance significantly;

5. Seamless approach to change the subscription profile by the MN; and

6. This approach works as an extension to personal firewall on all MN.

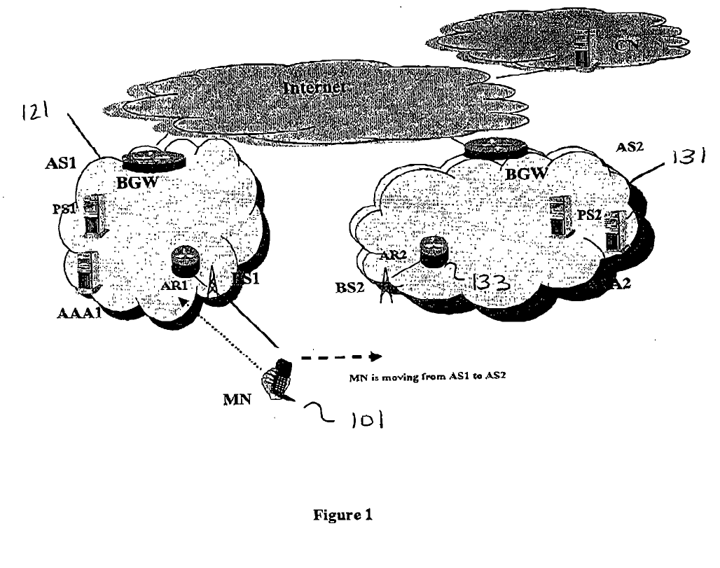

FIG. 1 shows the reference architecture for the context transfer framework. For example, when the MN 101 that is in AS1 121 moves to AS2 131, as per Policy based mechanisms for selecting access routers and mobile context relocation”,submitted IPR, U.S. application Ser. No. 60/336,937, Docket No. NC17419P, the context transfer takes place. It may happen that the new access router, e.g. AR2, 133 or the new communication path established cannot meet the needs of existing active sessions or possible future sessions. For example, it may be that the available bandwidth along the new path is less than that of the previous one. Hence QoS may degrade. It may also be that AR2 133 does not support an encryption algorithm the MN 101 may request for its future communication sessions.

An embodiment allows, after the context transfer is complete, AR2 133 sends the MN 101 a context completion message that includes the changes with AR capabilities and communication paths. The MN 101 then updates the working set filter accordingly.

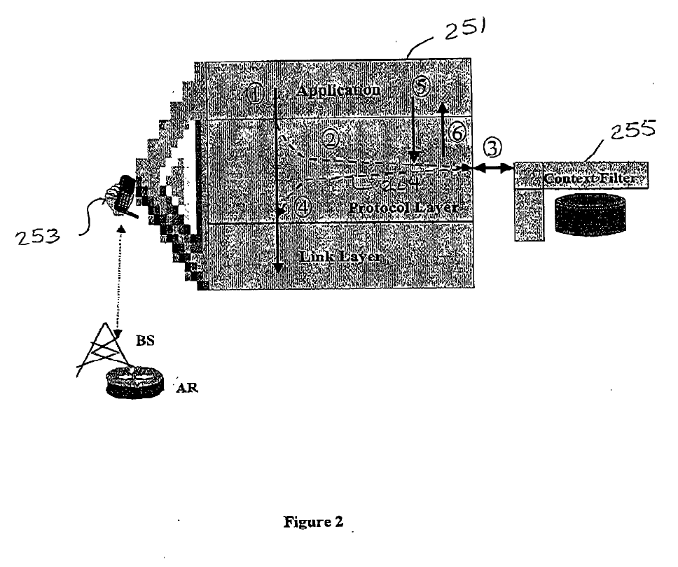

FIG. 2 shows how and when these filters are applied and used for normal operation in an exploded view of MN stack.

Precondition:

For example, MN 253 has started to roam (either in home network or switched on in the different network) in either case the context filter is created. The AR that is currently serving the MN 253 through Base Station (BS) updates the MN servicing profile to the MN 253. Upon receiving this message, MN 253 creates a context working set filters.

Operation (1):

1. For example, Application 251 (say A) has started and wants to communicate to its CN.

2. Protocol stack in the MN 253 consult the context filters 255.

3. Context filters rules are applied based on the current working set.

4. If the capabilities are meet then the packet is forwarded to the Core Network (CN).

Operation (2):

1. For example, Application (say A) has started and wants to communicate to its CN.

2. Protocol stack in the MN 253 consult the context filters 255.

3. Context filters rules are applied based on the current working set.

4. If the context filter rules are not meet then the protocol layer generates an error 204 (may be ICMP error) informing that this application cannot be executed and the application requirements are not meet.

5. It is up to the application to decide what to do next. It may give up or it may, for example, lower its requirements and initiate another session. In either case, messages that would be rejected by Access Router (AR) are never sent into the network.

What is claimed is:

1. A method for forwarding a packet of a mobile node, said mobile node in communication with an access router, said mobile node having a current working set and said access router having at least one capability comprising the steps of:
providing the packet to a protocol stack;
consulting a context filter;
applying at least one context filter rule based on the current working set; and
forwarding the packet based on at least one capability.

2. The method for forwarding a packet of claim 1 further comprising the step of:
creating a context working set filter prior to the step of providing the packet to a protocol stack.

3. The method for forwarding a packet of claim 2 further comprising the step of:
updating a mobile node servicing profile prior to the step of creating a context working set filter.

4. A method for forwarding a packet of a mobile node, said mobile node in communication with an access router, said mobile node having a current working set comprising the steps of:
starting an application;
consulting a context filter;
applying at least one context filter rule based on the current working set; and
generating an error provided that the at least one context filter rule is not met.

5. The method of forwarding of claim 4 further comprising the step of initiating a session.

6. The method of forwarding of claim 5 further comprising the step of giving up.

7. The method of forwarding of claim 4 wherein the step of generating an error comprises the step of generating an ICMP error.
